(19) United States
(12) Patent Application Publication
(10) Pub. No.: US 2014/0249908 A1
(43) Pub. Date: Sep. 4, 2014

(54) METHOD AND SYSTEM FOR PROMOTION CREATION AND REDEPTION

(71) Applicant: RETAILCOMMON INC., Toronto (CA)

(72) Inventors: John STAINES, Toronto (CA); Graydon Jefferies BUTLER, Toronto (CA); James Gordon Patrick CUNNINGHAM, Toronto (CA)

(21) Appl. No.: 14/191,101

(22) Filed: Feb. 26, 2014

Related U.S. Application Data
(60) Provisional application No. 61/769,592, filed on Feb. 26, 2013.

(51) Int. Cl. G06Q 30/02

(52) U.S. Cl. CPC G06Q 30/0225; G06Q 30/0276
USPC 705/14.26

(57) ABSTRACT

A method and system for the creation of coupons at a centralized server and distribution to multiple users is shown. The coupons are received at mobile devices and are redeemed at participating retail locations, which connect to an administration server that employs both an online and offline authentication process to ensure users are attempting to redeem valid coupon.

### CROSS REFERENCE TO RELATED APPLICATION

This application claims the benefit of U.S. Provisional Application No. 61/769,592 filed on Feb. 26, 2013 and the contents of U.S. Provisional Application No. 61/769,592 are hereby incorporated by reference in their entirety.

### FIELD

The various embodiments described herein relate generally to a method and system for managing the creation, publishing and distribution of promotions, and particularly to coupons and a method and system for tracking and authenticating their redemption.

### BACKGROUND

Traditionally, users have relied on reviewing newspapers and flyers for purposes of obtaining coupons or information regarding promotional materials, and consumers would manually collect and compile such coupons. With the advent of the Internet and its ever increasing use, more and more people have now come to rely on the Internet for purposes of determining whether any promotional offerings or coupons may exist for the products or services they are interested in. While the Internet may have a great deal of information available to consumers, many users find it cumbersome to have to locate coupons, print them and bring them to the retail location to be redeemed. Once at the retail location, the retailer will often undertake a manual process of inspecting the physical coupon to determine whether in fact the coupon is legitimate and whether in fact, the coupon may be redeemed. There is a need for a more efficient system and method for the creation, publishing, distribution and redemption of promotional offerings.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and in which:

FIG. 1 is a block diagram of the components of an exemplary promotion creation system;

FIG. 2 is a block diagram of the components of an administrator application in the system of FIG. 1;

FIG. 3 is a block diagram of the component of a promotion details module of the administrator application of FIG. 2;

FIG. 4 is a flowchart showing the steps of an exemplary promotion creation method;

FIG. 5 is a block diagram of the components of an exemplary corporate user module; and

FIG. 6 is a flowchart showing the steps of an exemplary coupon redemption method.

### DETAILED DESCRIPTION OF THE EMBODIMENTS

Various apparatuses or processes will be described below to provide an example of an embodiment of the claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing or divisional patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Furthermore, in the following passages, different aspects of the embodiments are defined in more detail. Each aspect so defined may be combined with any other aspect or aspects unless clearly indicated to the contrary. In particular, any feature indicated as being preferred or advantageous may be combined with at least one other feature or features indicated as being preferred or advantageous.

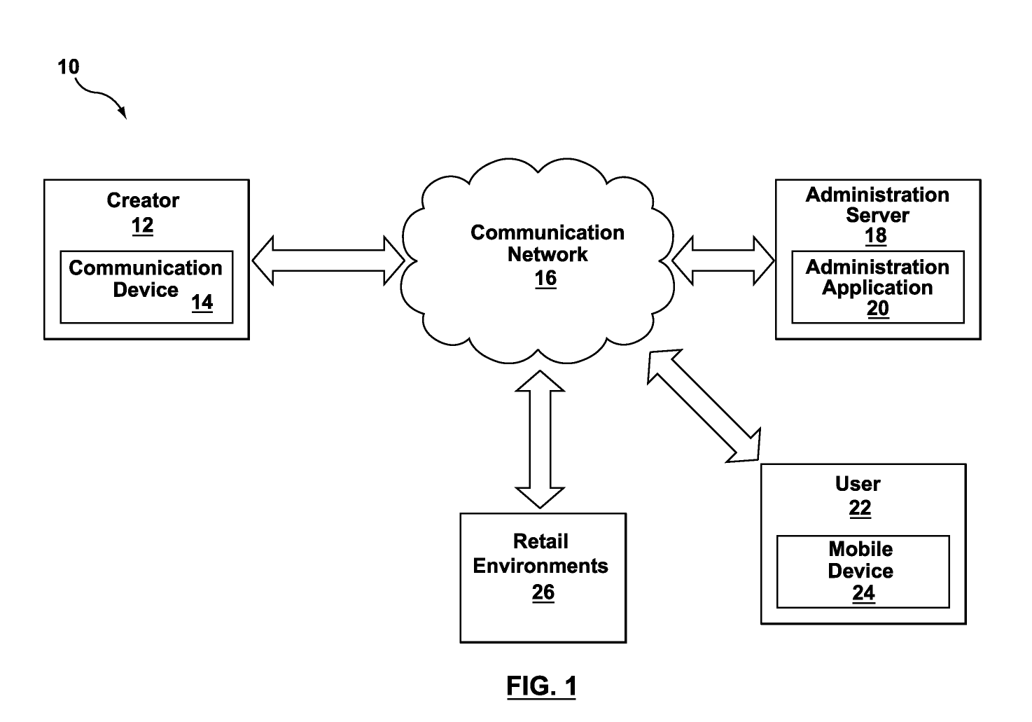

Reference is now made to FIG. 1, where one embodiment of a coupon creation system 10 is shown. The coupon creation system 10 comprises a creator 12 that accesses a communication device 14 to communicate with an administration server 18. The administration server 18 has resident upon it or associated with it, an administration application 20. The administration server 18 allows creators 12 to create, and distribute electronically, promotional coupons that may be used by users 22 through a redemption process involving a mobile device 24 at participating retail environments 26. The term coupon used herein is used to refer to any type of promotional offering, advertisement, information or any other such instrument that has associated with it the potential to provide the user with a monetary discount or other benefit when redeeming such coupon.

The creator 12 may be any user who wishes to create coupons. The creator 12 will generally be the owners and operators of retail stores, but as will be illustrated in further detail below, the creators 12 may be institutional in nature where they are creating coupons for multiple stores or locations under their control (for example this may be the owner or operator of a mall or the corporate headquarters for a big box store). Users may in certain embodiments be third party advertising agencies, or automated promotion generation systems directed by such agencies of any other commercial enterprise. The communication device 14 may be any personal computer, mobile computer type device or other network interface that allows users to provide input and has the ability to connect to communication network 16, which for example may be the Internet. The communication network 16 in an embodiment is the Internet. The administration server 18 in the embodiment is operated by an administrator of the system 10 to allow for creators 12 to create coupons and distribute them to users 20. The administration server 18 is a server type computing device that connects to the communication network 16. The administration application 22 running upon the administration server 18 in one embodiment creates a website that creators 12 use to create coupons. Once the coupon has been created the coupon will be distributed to users 22. Users 22 are any users who have or have access to a mobile device 24 who wish to redeem coupons at select retail environments 26. The retail environments 26 will accept the coupons from users 20 as further described below. The retail locations 24 may be any physical stores that participate in the system 10.

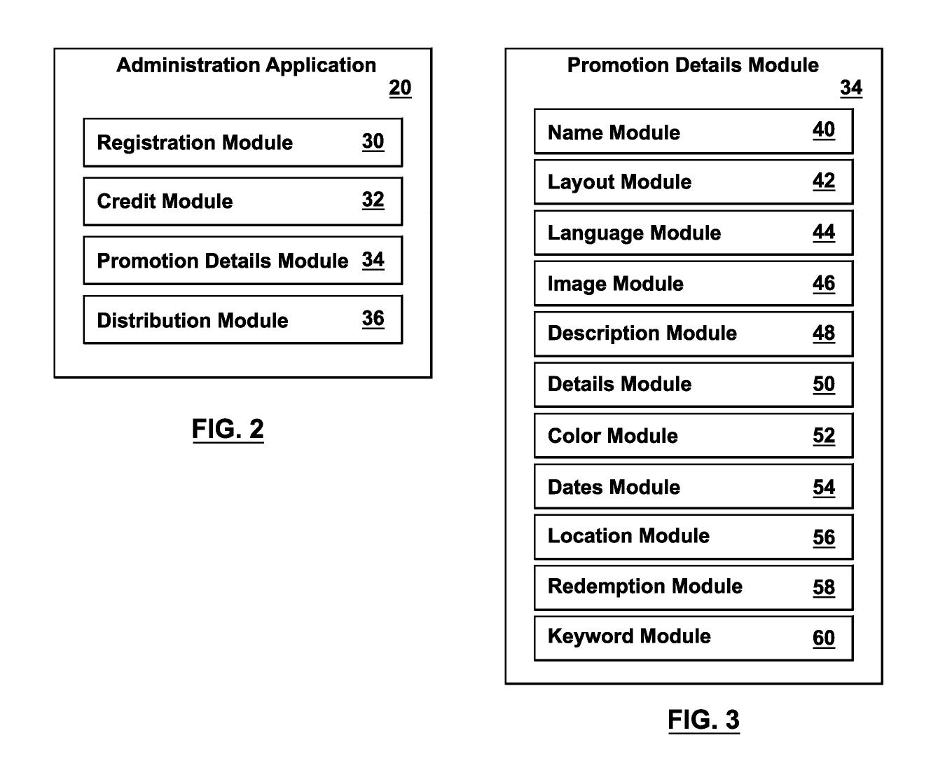

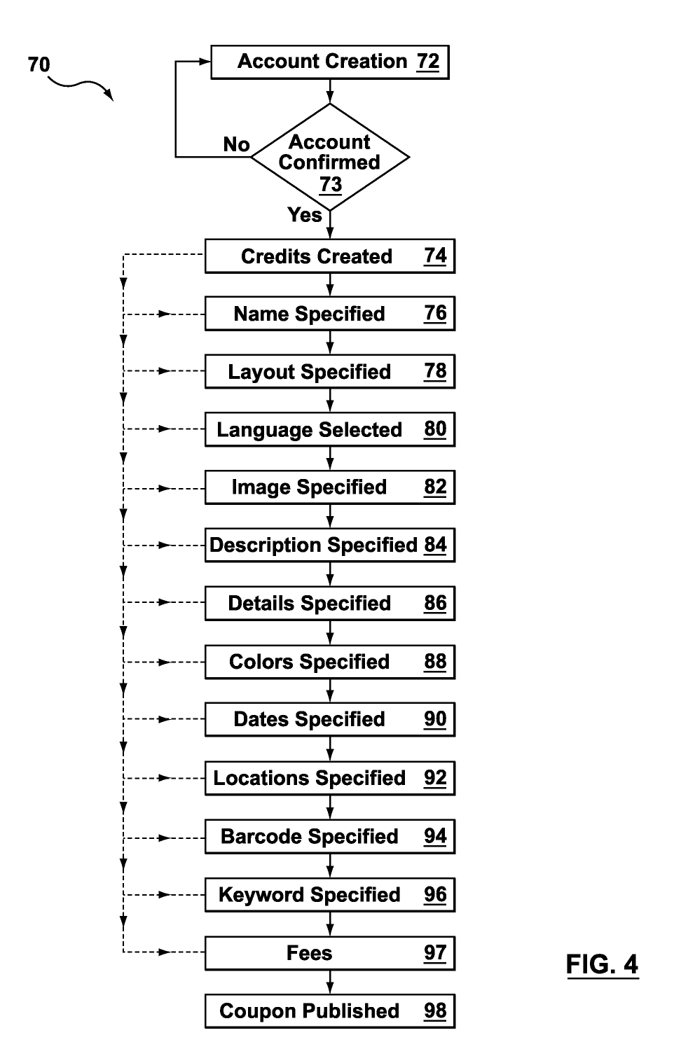

Reference is now made to FIG. 2 where the components of administration application 20 are illustrated in one embodiment. The administration application 20 shown in FIG. 2, the details module 34 illustrated in FIG. 3 and the coupon creation method 70 illustrated in FIG. 4 will together illustrate the functionality and options presented to a creator 12 that allows the creator 12 to create and distribute coupons in the exemplary embodiment.

The administration application 20 provides functionality to the creators 12 to be able to create coupons. The administration application 20 is comprised of a registration module 30, a credit module 32, a promotion details module 34 and a distribution module 36. The registration module 30 allows new users of the system 10, both creators 12 and users 22 to register for use of the system 10. The credit module 32 is used to track payments made by creators 12 for use of the system 10. The promotion details module 34 allows creators 12 to specify the details regarding their promotional offerings. The distribution module 36 allows creators 12 to distribute the created coupons to users 22 who may then redeem the promotional offerings.

Reference is now made to FIG. 3, where the sub components of the promotion details module 34 are illustrated in one embodiment. The promotion details module 34 allows creators 12 to specify details regarding their coupons and to customize coupons. The name module 40 allows the creator 12 to create a name for the coupon. The layout module 42 provides functionality that allows creators 12 to select from the various layout styles that are available for a coupon. The layout module 42 in one embodiment allows creators 12 two choices, the first being a layout style where a name for the coupon will be at the top of the coupon, and an image will be inserted below along with a description, and the second allows the creator 12 to have all of the information they desire included in an image that can be uploaded and will form the basis of the entire coupon. In other embodiments other present templates, or dynamically generated layouts, may be provided. The language module 44 is used to select the language of the coupon, along with generating any translations that may be required pursuant to applicable law or pursuant to the requirements of the creator 12. The image module 46 allows the creator 12 to select the image or images that will be part of the coupon. The description module 48 allows the user to select a headline that serves as the title for the coupon and provide a description for the coupon. The details module 50 allows the creator 12 to specify all of the details and any “fine print” associated with the promotional offerings through using common legal disclaimers that may be modified or by creating specific legal disclaimers. The color module 52 allows creators to select both the text and accent color to be used in the coupon. The text color will also be used as the foreground color and the accent color will be used as the background color for the headline and description sections of the coupon. The color module 52 allows creators 12 to select from a pallet of colors that most closely resemble the image that creator 12 provided. The dates module 54 allows creators 12 to specify the start and end dates for the validity of the coupon. The location module 56 allows users to specify the locations the coupon may be redeemed at. For each location the coupon may be redeemed at, the creator must provide a unique passcode that will be associated with the location. The operation of the passcode in validating the coupon is described in further detail below. The redemption module 58 provides, in an embodiment, a barcode that may be scanned at the point of sale to determine the authenticity of the coupon which may be used in place of the redemption passcode. The keyword module 60 associates with the coupon a keyword. Any keyword may be associated with a coupon, which allows creators 12 to create additional forms of promotional offerings. For example the creator 12 may run an advertisement or a point of sale promotion, where the user may email or text a certain keyword to an email address or phone number in order to receive a coupon that may be used one time for a significant discount. Such an offering will also (with the user's consent) serve as a means by which the creator can increase the number of people who receive and potentially use the coupon. It will be appreciated that in any embodiment, some or all of the above modules (and some or all of the features of each module) may be utilized for particular a coupon, and that in other embodiments, other characteristics of a coupon may be specified.

Reference is now made to FIG. 4 where the steps of a coupon creation method 70 are shown in one embodiment. The coupon creation method 70 is used by the creator 12 to create coupons. The creation method 70 begins at step 72 where the creator 12 is presented with the account creation steps at step 72. The account creation step requires a creator 12 to create an account with the system 10. Upon the creation of an account, method 70 proceeds to step 73, where a confirmation email is sent to the creator 12 via electronic mail and the creator 12 is asked to confirm their account details and validate that all of the information is correct. Where the check performed at step 73 determines that the information is not correct or the creator 12 has not in fact confirmed that the information is correct, the creator 12 is taken back to the account creation step at step 72. When the check performed at step 73 determines that the creator 12 has confirmed the account details, method 70 proceeds to step 74. At step 74, the creator's account is credited with a certain amount of credit which is used when a new coupon is published as described below. Method 70 then proceeds to step 76 where the creator 12 specifies the name that will be used to track the use and redemption of the coupon. Method 70 then proceeds to step 78 where the creator 12 selects the layout based on the options provided by the layout module 42. Method 70 then proceeds to step 80 where the creator selects the language for the coupon. Method 70 then proceeds to step 82 where the creator 12 specifies the image that is to be used with the coupon. The creator 12 may select the image from a predefined library of images or may upload a specific image. Method 70 then proceeds to step 84, where the creator 12 is required to provide details regarding the description of the coupon. Method 70 then proceeds to step 86 where the creator 12 specifies details regarding the coupon that may include providing the appropriate legal disclaimers. Method 70 then proceeds to step 88 where the colour information pursuant to the functionality of colour module 52 is chosen. Method 70 then proceeds to step 90 where the dates for the validity of the promotion are specified. Method 70 then proceeds to step 92 where the locations that will participate in the promotion (by accepting the coupon) are specified. For each location that is specified by the creator 12 as participating in the promotional offering, the creator 12 will specify a unique keyword that will be used is chosen at the time of redemption. Method 70 then proceeds to step 94 where a bar code is created which may be scanned at the point of sale by the participating retail establishment in order to validate the coupon. Method 70 then proceeds to step 96 where a creator 12 then creates a text keyword that is to be associated with the coupon. After the selection of the text keyword at step 96, method 70 then proceeds to step 97 where the fees that are payable by the creator 12 are shown to the creator 12. Method 70 then proceeds to step 98 where the coupon is ready for publishing. Once the coupon has been created it may be distributed to users. In one embodiment, the coupon is distributed by being published to a website. The website may be accessed directly through the URL, a bit.ly link or accessing the URL as embedded in a QR code. Users who receive this information regarding the website may share this information on various social networking sites and distribute to others through email or other such channels. It will be appreciated that in other embodiments, a different ordering of, different subset of, or additional steps may be specified depending on the creator 12's requirements and specifications, or requirements of a retail environment 26. The passcode may be distributed at the same time the coupon or promotional offering is published or separately.

The system and methods as have been described herein, are described with regards to a creator or store operator creating coupons for use by any one of their stores. The system and methods as described herein may also be used for purposes of allowing individual stores that may be part of the umbrella of a larger chain to be able to manage their own profiles and accounts.

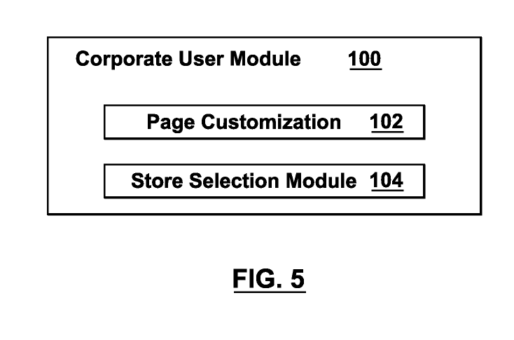

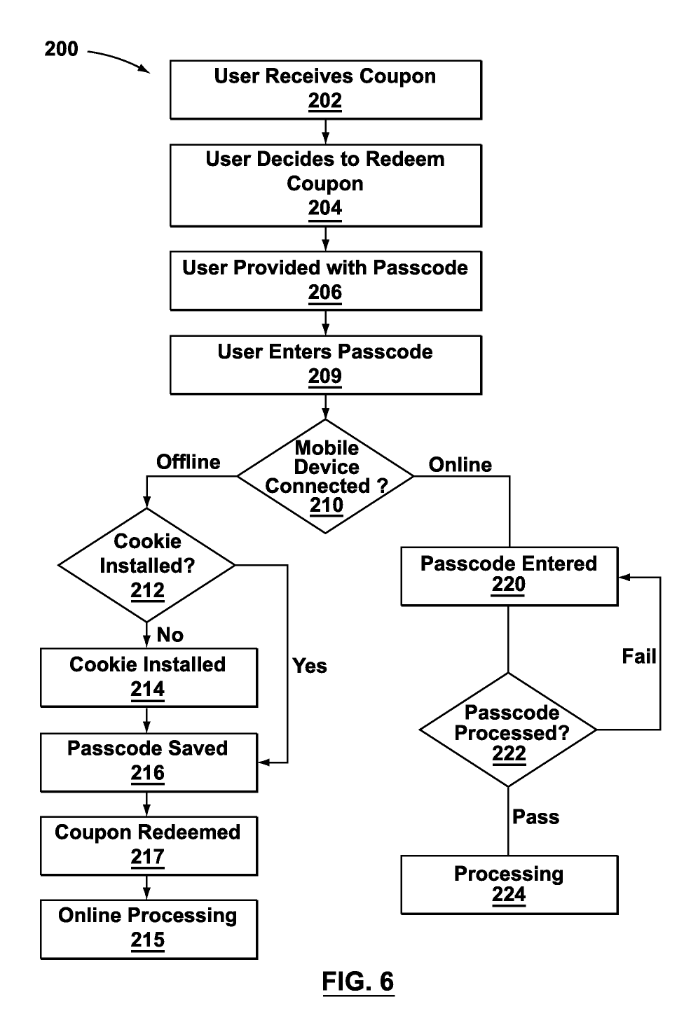

The systems and methods described above may be further enhanced and customized as described herein. With reference to FIGS. 5 and 6, a system and method is shown whereby the system 10 is customized for use by corporate users such as “big box” retailers and larger retail establishments that tend to require greater control over the promotional offerings that are being made to their respective customers. For purposes of illustrating the customizations and enhancements of the system 10 that may be made and may be furthered with regards to use by corporate users, reference is now made to FIG. 5 where the components of a corporate user module 100 are shown in one embodiment. The corporate user module 100 and its associated functionality are intended to illustrate the exemplary functionality that is presented to corporate users of the system 10. The corporate user module 100 may be made a part of the administration application 20 and is comprised of a page customization module 102 and a store selection module 104. When the system 10 is used by corporate users (which may in an embodiment be generally considered to be the head office of a corporation), the corporate user will be able to create entries in the system 10 that may be used by any of their stores. The customization module 102 allows corporate users to customize the functionality and appearance that will be displayed to store users when they access the respective page for stores hosted by the administration application. The corporate creator 12 may enter all of the information associated with their respective stores or locations through either manually entering such information, or uploading a file populated with such entries. The store customization module 104 then allows each respective store to customize their respective information, including the store location and hours. Each store may then be viewed as a creator 12 who can then create and distribute coupons that may be used at their respective store.

In order for a user 22 to use a coupon, the system will perform validation on the coupon to determine whether a coupon presented by a user 22 is in fact authentic and still valid. Reference is now made to FIG. 6, where the steps of a coupon redemption method 200 are shown in one embodiment. The coupon redemption method 200 illustrates the steps and processes that are undertaken when a coupon is redeemed by a user 22 at a point of sale location, regardless of whether the user 22 is online or offline. Method 200 begins at step 202, where the user 22 has loaded on, for example, their mobile device's web browser a coupon that has been created through use of the system 10. The coupon will have associated with it attributes associated with its use, including location, expiry dates, amounts and other appropriate restrictions and/or features. At step 204, the user 22 then determines that they wish to redeem the coupon when making a purchase at a participating retail location 26. When making a purchase, the user 22 will present the coupon that is loaded, for example upon a browser or specialized app on their mobile device to the retailer. Method 200 then proceeds to step 206 where the user 22 is provided with the passcode that is associated with the particular retail location 26 by the retailer. Method 200 then proceeds to step 208 where the user 22 enters the passcode in the field specified. The coupon as loaded on a website (or app) will have a field that allows for the entering of the passcode. Method 200 then proceeds to step 210 where a determination is made as to whether the mobile device is able to connect to the administration server 18 or not. If it is determined at step 210 that the mobile device is offline and that the mobile device is not able to connect to the administration server, method 200 then proceeds to step 212 where a check is performed to determine whether an offline redemption cookie, or other verification key or data string, has been installed or stored on the mobile device. If step 212 determines that offline redemption data is not installed or stored, then method 200 proceeds to step 214, whereupon a cookie is installed or the appropriate data stored, and then the passcode and the user 22's use of the passcode are saved to the cookie or data. If it is determined at step 210 that an offline authentication or redemption data (such as a cookie) is installed or stored, then method 200 proceeds to step 216 where the passcode entered by the user is stored in the cookie (or data). Upon the conclusion of steps 214 and 216 respectively, method 200 then proceeds to step 217 where the coupon is redeemed at the retail location 26.

Method 200 then proceeds to step 218 where the next time the communication device is online, the information that has been written to the cookies or data are processed by the administration server. Upon the information being processed, the administration application is able to track which coupons have been redeemed and at which location. If the check performed at step 210 determines that the mobile device is online, method 200 proceeds to step 220. At step 220 the passcode that is entered by the user 22 is compared to the passcode that is stored at the authentication server 18. Method 200 then proceeds to step 222 where a check is performed to determine if the passcode is correct along with determining whether the parameters associated with the promotional offering allow for its redemption If at step 222 it is determined that the passcode is correct, the user is able to redeem the coupon. If at step 222 it is determined that the passcode is incorrect the user 22 is required to reenter the passcode. Such process will repeat itself a limited number of times until the user 22 has entered the appropriate passcode or the system locks the user 22 out. In alternative embodiments, the user may redeem the promotional offering through the scanning of a bar code at a point of sale, or based upon being validated as being in a permitted location where the coupon is valid as determined based on positional data as taken from the user's mobile device.

At least some of the elements of the system 10 that are implemented via software may be written in a high-level procedural language such as object oriented programming or a scripting language. Accordingly, the program code may be written in C, C++, SQL or any other suitable programming language and may comprise modules or classes, as is known to those skilled in object oriented programming. At least some of the elements of the system 10 that are implemented via software may be written in assembly language, machine language or firmware as needed. In either case, the program code can be stored on a storage media or on a computer readable medium that is readable by a general or special purpose programmable computing device having a processor, an operating system and the associated hardware and software that is necessary to implement the functionality of at least one of the embodiments described herein. The program code, when read by the computing device, configures the computing device to operate in a new, specific and predefined manner in order to perform at least one of the methods described herein.

Furthermore, at least some of the methods described herein are capable of being distributed in a computer program product comprising a computer readable medium that bears computer usable instructions for one or more processors. The medium may be provided in various forms such as, but not limited to, one or more diskettes, compact disks, tapes, chips, USB keys, external hard drives, wire-line transmissions, satellite transmissions, internet transmissions or downloads, magnetic and electronic storage media, digital and analog signals, and the like. The computer usable instructions may also be in various forms, including compiled and non-compiled code.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

What is claimed is:

1. A computer implemented method for validating a promotional offering, comprising:
a) receiving parameters at an administration server associated with the promotional offering to be satisfied for the promotional offering to be validated;
b) generating a code at the administration sever linked to the promotional offering;
c) distributing the promotional offering and the code from the administration server to a recipient;
d) at the time of redemption of the promotional offering by the recipient,
i) receiving from a mobile device at the administration server the code linked to the promotional offering,
ii) validating the code with the promotional offering by the administration server,
iii) determining that the parameters associated with the promotional offering are validated by the administration server, and
iv) sending a validation message from the administration server to the mobile device to validate the promotional offering.

2. The computer implemented method of claim 1, wherein the parameters comprise at least one of more of the locations where the promotional offering may be used, and the time period during which it may be used.

3. The computer implemented method of claim 1, wherein the code comprises a unique passcode.

4. The computer implemented method of claim 1, wherein the code comprises a barcode.

5. The computer implemented method of claim 1, wherein the promotional offering is distributed through email.

6. The computer implemented method of 1, wherein the promotional offering is distributed through social media.

7. A computer readable memory having recorded thereon statements and instructions for execution by a computer, said statements and instructions comprising:
a) code means for receiving parameters at an administration server associated with the promotional offering to be satisfied for the promotional offering to be validated;
b) code means for generating a code at the administration sever linked to the promotional offering;
c) code means for distributing the promotional offering and the code from the administration server to a recipient;
d) code means for at the time of redemption of the promotional offering by the recipient,
i) receiving from a mobile device at the administration server the code linked to the promotional offering,
ii) validating the code with the promotional offering by the administration server,
iii) determining that the parameters associated with the promotional offering are validated by the administration server, and
iv) sending a validation message from the administration server to the mobile device to validate the promotional offering.

8. The computer readable memory of claim 7, wherein the parameters comprise at least one of more of the locations where the promotional offering may be used, and the time period during which it may be used.

9. The computer readable memory of claim 7, wherein the code comprises a unique passcode.

10. The computer readable memory of claim 7, wherein the code comprises a barcode.

11. The computer readable memory of claim 7, wherein the promotional offering is distributed through email.

12. The computer readable memory of claim 7, wherein the promotional offering is distributed through social media.
